(19) United States
(12) Patent Application Publication
(10) Pub. No.: US 2010/0201113 A1
(43) Pub. Date: Aug. 12, 2010

(54) MULTIPURPOSE COVER SUPPORTER

(76) Inventor: Jeong Woo Park, Choongnam (KR)

Correspondence Address: IPLA P.A., 3550 WILSHIRE BLVD., 17TH FLOOR, LOS ANGELES, CA, 90010, US

(21) Appl. No.: 12/678,986

(22) PCT Filed: Sep. 19, 2008
(86) PCT No.: PCT/KR08/05558

§ 371 Date: Mar. 18, 2010

(30) Foreign Application Priority Data
Aug. 31, 2007 (KR) 10-2007-0088518
Jan. 14, 2008 (KR) 10-2008-0003903
May 26, 2008 (KR) 10-2008-0048488

(51) Int. Cl. B42D 3/00

(52) U.S. Cl. 281/15.1

(57) ABSTRACT

A multipurpose cover supporter includes a front cover (20) and a rear cover (30) foldably connected with each other by a main connection part (10); first front and rear foldable covers (25 and 35) connected to outer surfaces of the front and rear covers (20 and 30) along first folding lines (25a and 35a) and overlapping with the front and rear covers (20 and 30); second front and rear foldable covers (26 and 36) connected to the outer surfaces of the front and rear covers (20 and 30) along second folding lines (26a and 36a) above the first front and rear foldable covers (25 and 35) and overlapping with the front and rear covers (20 and 30); first angle maintaining parts connected between the front and rear covers (20 and 30) and the first front and rear foldable covers (25 and 35) to maintain an angle defined therebetween when they are unfolded from each other; and second angle maintaining parts connected between the front and rear covers (20 and 30) and the second front and rear foldable covers (26 and 36) to maintain an angle defined therebetween when they are unfolded from each other.

### TECHNICAL FIELD

The present invention relates to a multipurpose cover supporter which can be applied to various types of products, and more particularly, to a multipurpose cover supporter which has improved portability and usability.

### BACKGROUND ART

In the products having inner sheets which include contents to be explained or checked and covers which are provided to both front and rear ends of the inner sheets, for example, books, notebooks, memo books, albums, magazines, name card holders, diaries, calendars, brochures of insurance companies, banks, etc., electronic diaries, and so forth, when the inner sheets are to be used or recording is to be made on the inner sheets, it is necessary to bend the body and lower the head with the product placed on a table.

When the body is bent and the head is hung, adverse influences are likely to be exerted on the back and the eyes. If this posture is repeatedly assumed over a long period, spinal disorders, amblyopia, empyema, study efficiency deterioration, etc. can be caused.

### DISCLOSURE OF INVENTION

### Technical Problem

Accordingly, the present invention has been made in an effort to solve the problems occurring in the related art, and an object of the present invention is to provide a multipurpose cover supporter which can maximize convenience since it can be used without the need for bending the body or hanging the head down, and which has improved portability.

### Technical Solution

In order to achieve the above object, according to one aspect of the present invention, there is provided a multipurpose cover supporter comprising a front cover (20) and a rear cover (30) foldably connected with each other by a main connection part (10); first front and rear foldable covers (25 and 35) connected to outer surfaces of the front and rear covers (20 and 30) along first folding lines (25a and 35a) and overlapping with the front and rear covers (20 and 30); second front and rear foldable covers (26 and 36) connected to the outer surfaces of the front and rear covers (20 and 30) along second folding lines (26a and 36a) above the first front and rear foldable covers (25 and 35) and overlapping with the front and rear covers (20 and 30); first angle maintaining parts connected between the front and rear covers (20 and 30) and the first front and rear foldable covers (25 and 35) to maintain an angle defined therebetween when they are unfolded from each other; and second angle maintaining parts connected between the front and rear covers (20 and 30) and the second front and rear foldable covers (26 and 36) to maintain an angle defined therebetween when they are unfolded from each other.

In order to achieve the above object, according to another aspect of the present invention, there is provided a multipurpose cover supporter comprising a front cover (120) and a rear cover (130) foldably connected with each other by a main connection part (110); first front and rear foldable covers (125 and 135) connected to outer surfaces of the front and rear covers (120 and 130) along common folding lines (125a and 135a) and overlapping with the front and rear covers (120 and 130); second front and rear foldable covers (126 and 136) connected to the outer surfaces of the first front and rear foldable covers (125 and 135) along the common folding lines (125a and 135a) and overlapping with the first front and rear foldable covers (125 and 135); first angle maintaining parts (1045) connected between the front and rear covers (120 and 130) and the first front and rear foldable covers (125 and 135) to maintain an angle defined therebetween when they are unfolded from each other; and second angle maintaining parts (1046) connected between the first front and rear foldable covers (125 and 135) and the second front and rear foldable covers (126 and 136) to maintain an angle defined therebetween when they are unfolded from each other.

In order to achieve the above object, according to still another aspect of the present invention, there is provided a multipurpose cover supporter comprising a front cover (220) and a rear cover (230) foldably connected with each other by a main connection part (210); first front and rear foldable covers (225 and 235) connected to outer surfaces of the front and rear covers (220 and 230) along folding lines (225a and 235a), overlapping with the front and rear covers (220 and 230), and defined with front and rear openings (226b and 236b); second front and rear foldable covers (226 and 236) positioned in the front and rear openings (226b and 236b), connected to the outer surfaces of the front and rear covers (220 and 230) along folding lines (226a and 236a) inside the front and rear openings (226b and 236b), and overlapping with the front and rear covers (220 and 230); first angle maintaining parts (1145) connected between the front and rear covers (220 and 230) and the first front and rear foldable covers (225 and 235) to maintain an angle defined therebetween when they are unfolded from each other; and second angle maintaining parts (1146) connected between the front and rear covers (220 and 230) and the second front and rear foldable covers (226 and 236) to maintain an angle defined therebetween when they are unfolded from each other.

The features and advantages of the present invention will become more apparent after a reading of the following detailed description taken in conjunction with the drawings. It is to be understood that the terms or words used in the description and the following claims must not be construed to have meanings which are general or may be found in a dictionary. Therefore, considering the notion that an inventor can most properly define the concepts of the terms or words to best explain his or her invention, the terms or words must be understood as having meanings or concepts that conform to the technical spirit of the present invention.

### Advantageous Effects

Thanks to the above features, the multipurpose cover supporter according to the present invention includes a front foldable cover which is connected to the upper portion of a front cover along a folding line, a rear foldable cover which is connected to the upper portion of a rear cover along a folding line, and angle maintaining parts which maintain an angle between the front and rear covers and the front and rear foldable covers unfolded from each other. As a consequence, the multipurpose cover supporter can be carried by folding it like a book and can be used by unfolding and erecting it like a book stand.

Accordingly, when checking recorded inner sheets, it is not necessary to bend the body or hang the head. Also, since the inner sheets can be easily replaced, usability of the multipurpose cover supporter can be improved.

### BRIEF DESCRIPTION OF THE DRAWINGS

FIG. 1 is a perspective view illustrating a first embodiment of a multipurpose cover supporter according to the present invention;

FIG. 2 is a view illustrating a first embodiment of a first angle maintaining part for erecting front and rear covers and first front and rear foldable covers, in the multipurpose cover supporter shown in FIG. 1;

FIG. 3 is a side view of the multipurpose cover supporter shown in FIG. 2, illustrating the state in which the front and rear covers are erected by the first front and rear foldable covers;

FIG. 4 is a side view of the multipurpose cover supporter shown in FIG. 2, illustrating the state in which the front and rear covers are erected by second front and rear foldable covers;

FIGS. 5 and 6 are views illustrating a second embodiment of the first angle maintaining part for erecting front and rear covers and first front and rear foldable covers, in the multipurpose cover supporter shown in FIG. 1;

FIG. 7 is a view illustrating an example of a detachable support part in the multipurpose cover supporter shown in FIG. 1;

FIG. 8 is a view illustrating a third embodiment of the first angle maintaining part for erecting front and rear covers and first front and rear foldable covers, in the multipurpose cover supporter shown in FIG. 1;

FIG. 9 is a view illustrating a fourth embodiment of the first angle maintaining part for erecting front and rear covers and first front and rear foldable covers, in the multipurpose cover supporter shown in FIG. 1;

FIG. 10 is a view illustrating a fifth embodiment of the first angle maintaining part for erecting front and rear covers and first front and rear foldable covers, in the multipurpose cover supporter shown in FIG. 1;

FIG. 11 is a view illustrating a sixth embodiment of the first angle maintaining part for erecting front and rear covers and first front and rear foldable covers, in the multipurpose cover supporter shown in FIG. 1;

FIG. 12 is a view illustrating a seventh embodiment of the first angle maintaining part for erecting front and rear covers and first front and rear foldable covers, in the multipurpose cover supporter shown in FIG. 1;

FIG. 13 is a view illustrating an eighth embodiment of the first angle maintaining part for erecting front and rear covers and first front and rear foldable covers, in the multipurpose cover supporter shown in FIG. 1;

FIG. 14 is a view illustrating a ninth embodiment of the first angle maintaining part for erecting front and rear covers and first front and rear foldable covers, in the multipurpose cover supporter shown in FIG. 1;

FIG. 15 is a view illustrating a tenth embodiment of the first angle maintaining part for erecting front and rear covers and first front and rear foldable covers, in the multipurpose cover supporter shown in FIG. 1;

FIG. 16 is an exploded perspective view independently illustrating the first angle maintaining part shown in FIG. 15;

FIG. 17 is a view illustrating an eleventh embodiment of the first angle maintaining part for erecting front and rear covers and first front and rear foldable covers, in the multipurpose cover supporter shown in FIG. 1;

FIG. 18 is a view illustrating a main connection part comprising a spring in the multipurpose cover supporter shown in FIG. 1;

FIG. 19 is a view illustrating the state in which the multipurpose cover supporter shown in FIG. 18 is folded like a book;

FIG. 20 is a view illustrating the state in which a connection member for connecting the first front and rear foldable covers is not adopted, in the multipurpose cover supporter shown in FIG. 18;

FIG. 21 is a view illustrating the state in which first and second front foldable covers and first and second rear foldable covers are not connected, in the multipurpose cover supporter shown in FIG. 1;

FIG. 22 is a view illustrating third front and rear foldable covers and a third angle maintaining part which are formed above the second front and rear foldable covers, in the multipurpose cover supporter shown in FIG. 1;

FIG. 23 is a view illustrating the state in which the front and rear covers are erected by the second and third front and rear foldable covers, in the multipurpose cover supporter shown in FIG. 22;

FIG. 24 is a view illustrating the state in which the front and rear covers are erected by the first front and rear foldable covers, in the multipurpose cover supporter shown in FIG. 22;

FIG. 25 is a perspective view illustrating a second embodiment of the multipurpose cover supporter according to the present invention;

FIG. 26 is a view illustrating the state in which third front and rear foldable covers and a third angle maintaining part are formed over first and second front and rear foldable covers, in the multipurpose cover supporter shown in FIG. 25;

FIG. 27 is a perspective view illustrating a third embodiment of the multipurpose cover supporter according to the present invention; and

FIG. 28 is a view illustrating the state in which a second front foldable cover and a second rear foldable cover are connected by a sub connection part, in the multipurpose cover supporter shown in FIG. 27.

### DESCRIPTION OF REFERENCE NUMERALS FOR MAIN PARTS IN DRAWINGS

10: main connection part 10a: folding lines

15: first sub connection part 15a: folding lines

16: second sub connection part 16a: folding lines

20, 30: front and rear covers 22, 32: fitting grooves

22a, 32a: engagement grooves

25, 35: first front and rear foldable covers

25a, 35a: first folding lines

26, 36: second front and rear foldable covers

26a, 36a: second folding lines

27, 37: third front and rear foldable covers

27a, 37a: third folding lines

51a, 51b: first attachment parts

52a, 52b: second attachment parts

45: first angle maintaining parts

46: second angle maintaining parts

47: third angle maintaining parts

145: first angle maintaining parts

245: first angle maintaining parts

345: first angle maintaining parts

445: first angle maintaining parts

545: first angle maintaining parts

645: first angle maintaining parts

745, 746: first angle maintaining parts

845, 846: first angle maintaining parts

945, 946: first angle maintaining parts

1045: first angle maintaining parts

110: main connection part 110a: folding lines

115: first sub connection part 115a: folding lines

116: second sub connection part 116a: folding lines

120, 130: front and rear covers

125, 135: first front and rear foldable covers

125′, 135′: step portions

125a, 135a: common folding lines

126, 136: second front and rear foldable covers

151a, 151b: first attachment parts

152a, 152b: second attachment parts

210: main connection part 210a: folding lines

215: first sub connection part 215a: folding lines

216: second sub connection part 216a: folding lines

220, 230: front and rear covers

225, 235: first front and rear foldable covers

226, 236: second front and rear foldable covers

251a, 251b: first attachment parts

252a, 252b: second attachment parts

### MODE FOR THE INVENTION

Hereafter, a multipurpose cover supporter according to the present invention will be described with reference to the accompanying drawings.

Wherever possible, the same reference numerals will be used throughout the drawings and the description to refer to the same or like parts. In the following explanation of the present invention, the detailed description of known functions and configurations incorporated herein will be omitted when it may make the subject matter of the present invention rather unclear.

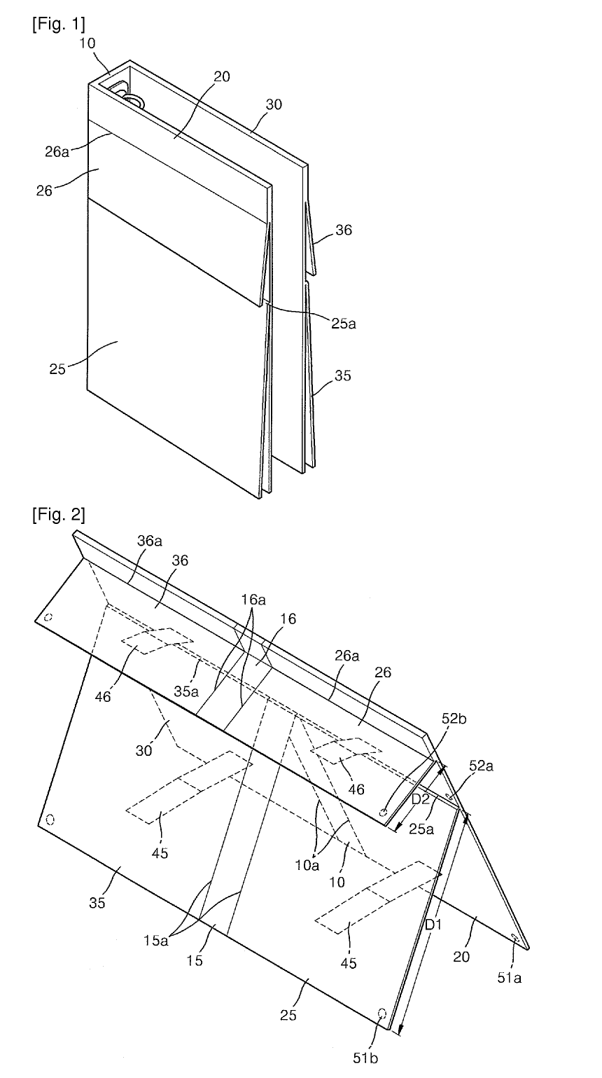

FIG. 1 is a perspective view illustrating a first embodiment of a multipurpose cover supporter according to the present invention, FIG. 2 is a view illustrating a first embodiment of a first angle maintaining part for erecting front and rear covers and first front and rear foldable covers, in the multipurpose cover supporter shown in FIG. 1,

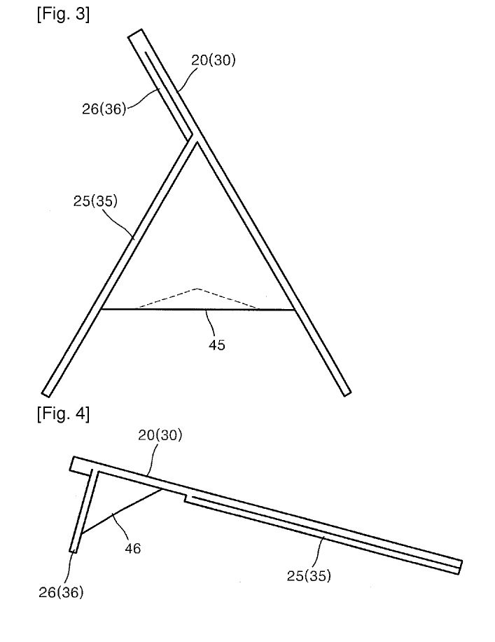

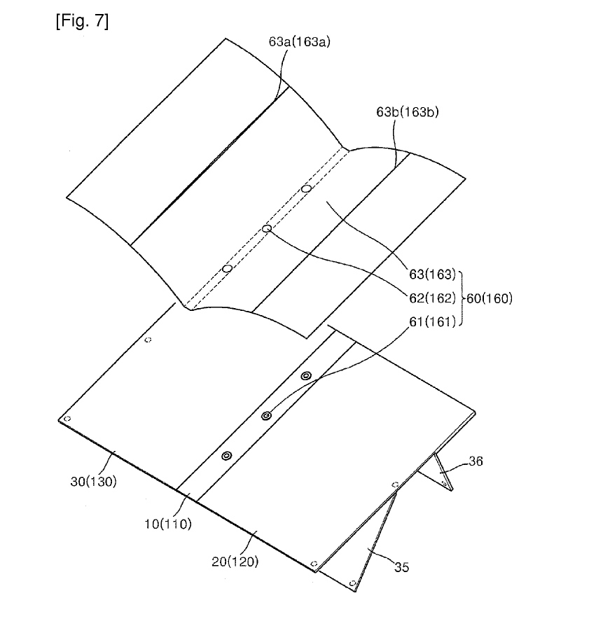

FIG. 3 is a side view of the multipurpose cover supporter shown in FIG. 2, illustrating the state in which the front and rear covers are erected by the first front and rear foldable covers, and FIG. 4 is a side view of the multipurpose cover supporter shown in FIG. 2, illustrating the state in which the front and rear covers are erected by second front and rear foldable covers. FIG. 7 is a view illustrating an example of a detachable support part in the multipurpose cover supporter shown in FIG. 1.

Referring to these drawings, a first embodiment of a multipurpose cover supporter according to the present invention includes a front cover 20 and a rear cover 30 foldably connected with each other by a main connection part 10; first front and rear foldable covers 25 and 35 connected to the outer surfaces of the front and rear covers 20 and 30 along first folding lines 25a and 35a and overlapping with the front and rear covers 20 and 30; second front and rear foldable covers 26 and 36 connected to the outer surfaces of the front and rear covers 20 and 30 along second folding lines 26a and 36a above the first front and rear foldable covers 25 and 35 and overlapping with the front and rear covers 20 and 30; first angle maintaining parts connected between the front and rear covers 20 and 30 and the first front and rear foldable covers 25 and 35 to maintain an angle defined therebetween when they are unfolded from each other; and second angle maintaining parts connected between the front and rear covers 20 and 30 and the second front and rear foldable covers 26 and 36 to maintain an angle defined therebetween when they are unfolded from each other.

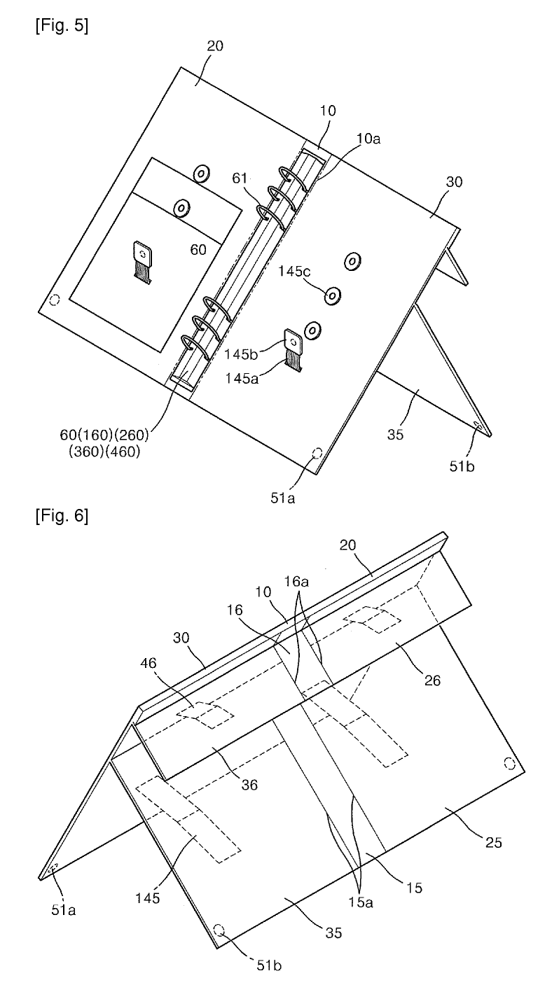

At this time, preferably, as shown in FIG. 5, detachable support parts 60 for detachably supporting inner sheets (not shown) to be printed with various information or to be recorded with something are installed on the main connection part 10 and on any one or both of the front cover 20 and the rear cover 30.

The detachable support parts 60 can be realized in various shapes. For example, as shown in FIG. 7, the detachable support part 60 can comprise first attachment and detachment portions 61 which are installed on the main connection part 10, the front cover 20 or the rear cover 30 at predetermined intervals, an inner sheet support portion 63 having pockets 63a and 63b into which the front and rear surface portions of a book or other various inner sheets are respectively fitted, and second attachment and detachment portions 62 which are installed at a place where the inner sheet support portion 63 is to be bound and which are attached to and detached from the first attachment and detachment portions 61. At this time, the first and second attachment and detachment portions 61 and 62 can be realized by magnets and steel pieces, or magnets having opposite polarities.

Also, the detachable support part can be realized by a conventional spring binder which is installed on the main connection part 10, a clip which is installed on any one of the front cover 20 and the rear cover 30 or on the upper end of any one of the front cover 20 and the rear cover 30 and detachably supports the upper ends of the inner sheets, a pocket which is formed on the inner surface of the front cover 20 and/or the rear cover 30 to allow memo papers or name cards to be slipped therein, or a plurality of vinyl pouches which are installed on the main connection part 10 to receive papers. Additionally, the detachable support part can be realized by rubber bands which are installed on the front cover 20 and the rear cover 30, respectively, in the longitudinal direction.

Since the front and rear covers and the first and second front and rear foldable covers should have some rigidity so as to be erected on a table, they can be manufactured by injection-molding polypropylene (generally called PP) having relatively high strength and a low manufacturing cost, or can be made of acryl, paper such as hardboard, plastic, aluminum, wood, etc. Also, in order to increase the quality of the cover supporter according to the present invention, the front and rear covers 20 and 30 can be covered with natural leather, synthetic leather or cloth, or can be rounded on the corners thereof.

As shown in FIG. 2, the height D1 of the first front and rear foldable covers 25 and 35 is determined to be greater than the height D2 of the second front and rear foldable covers 26 and 36. Of course, it can be envisaged that the height D1 of the first front and rear foldable covers 25 and 35 is determined to be less than the height D2 of the second front and rear foldable covers 26 and 36.

It is illustrated in FIG. 1 that the lower ends of the first front and rear foldable covers 25 and 35 are flush with the lower ends of the front and rear covers 20 and 30. In this regard, of course, it can be envisaged that the lower ends of the first front and rear foldable covers 25 and 35 are positioned higher than the lower ends of the front and rear covers 20 and 30.

Also, while it is illustrated in FIG. 1 that the second folding lines 26a and 36a for connecting the second front and rear foldable covers 26 and 36 to the front and rear covers 20 and 30 are formed on the upper portions of the front and rear covers 20 and 30, it can of course be envisaged that the second folding lines 26a and 36a can be formed on the upper ends of the front and rear covers 20 and 30.

The main connection part 10 connects the front cover 20 and the rear cover 30 along folding lines 10a on both side ends thereof.

The first front foldable cover 25 and the first rear foldable cover 35 are connected with each other by a first sub connection part 15 along folding lines 15a, and the second front foldable cover 26 and the second rear foldable cover 36 are connected with each other by a second sub connection part 16 along folding lines 16a.

First attachment parts 51a and 51b are formed on the lower end corners of the first front and rear foldable covers 25 and 35 and on the lower end corners of the front and rear covers 20 and 30 such that the first front and rear foldable covers 25 and 35 can be kept in the state in which they overlap with the front and rear covers 20 and 30. The first attachment parts 51a and 51b can be composed of Velcro-brand hook and loop fastener strips, magnets and steel pieces, magnets having opposite polarities, magnetic buttons, or non-magnetic buttons.

Second attachment parts 52a and 52b are formed on the lower end corners of the second front and rear foldable covers 26 and 36 and the portions of the front and rear covers 20 and 30 which correspond to the lower end corners of the second front and rear foldable covers 26 and 36 such that the second front and rear foldable covers 26 and 36 can be kept in the state in which they overlap with the front and rear covers 20 and 30. The second attachment parts 52a and 52b can be composed of Velcro-brand hook and loop fastener strips, magnets and steel pieces, magnets having opposite polarities, or non-magnetic buttons.

The second angle maintaining parts 46 function to hold the front and rear covers 20 and 30 and the second front and rear foldable covers 26 and 36 in the unfolded state so as to allow the multipurpose cover supporter according to the present invention to be erected. The second angle maintaining parts 46 comprise band members which are connected between and fastened to the front and rear covers 20 and 30 and the second front and rear foldable covers 26 and 36. The second angle maintaining parts 46 are folded when the second front and rear foldable covers 26 and 36 are folded to the front and rear covers 20 and 30.

The first angle maintaining parts function to hold the front and rear covers 20 and 30 and the first front and rear foldable covers 25 and 35 in the unfolded state so as to allow the multipurpose cover supporter according to the present invention to be erected at a different angle. The first angle maintaining parts can be realized in various shapes.

As shown in FIGS. 2 and 3, a first embodiment 45 of the first angle maintaining parts comprises band members which are connected between and fastened to the front and rear covers 20 and 30 and the first front and rear foldable covers 25 and 35.

At this time, in the case where the width of the band members constituting the first angle maintaining parts 45 is increased, the first angle maintaining parts 45 can have the same width as the first front and rear foldable covers 25 and 35 and the front and rear covers 20 and 30. Also, a single band member can constitute the first embodiment of the first angle maintaining part 45. In this case, the first angle maintaining part 45 is connected between the main connection part 10 and the sub connection part 15. Thus, the number and the size of the first angle maintaining parts 45 can be changed in a variety of ways.

FIGS. 5 and 6 are views illustrating a second embodiment of the first angle maintaining part for erecting front and rear covers and first front and rear foldable covers, in the multipurpose cover supporter shown in FIG. 1.

A second embodiment 145 of the first angle maintaining part can be realized in the structure shown in FIGS. 5 and 6. That is to say, the first angle maintaining parts 145 include band members 145a which are connected to the first front and rear foldable covers 25 and 35 and are fastened to the lower portions of the front and rear covers 20 and 30, first attachment and detachment elements 145b which are formed on the upper portions of the front and rear covers 20 and 30 at preselected intervals, and second attachment and detachment elements 145c which are installed on the band members 145a and can be attached to and detached from the first attachment and detachment elements 145b.

The band members 145a have the shape of a band and are formed of cloth, plastic, poly resin, leather, paper, etc. Also, the first and second attachment and detachment elements 145b and 145c can be composed of Velcro-brand hook and loop fastener strips, magnets and steel pieces, magnets having opposite polarities, or non-magnetic buttons.

It can be contemplated that the band members 145a pass through the slots (not numbered) defined through the lower portions of the front and rear covers 20 and 30, are fastened to the lower ends of the front and rear covers 20 and 30, or are fastened to the side ends of the front and rear covers 20 and 30. Also, a single first angle maintaining part 145 can constitute the second embodiment, and in this case, the first angle maintaining part 145 is connected between the main connection part 10 and the sub connection part 15.

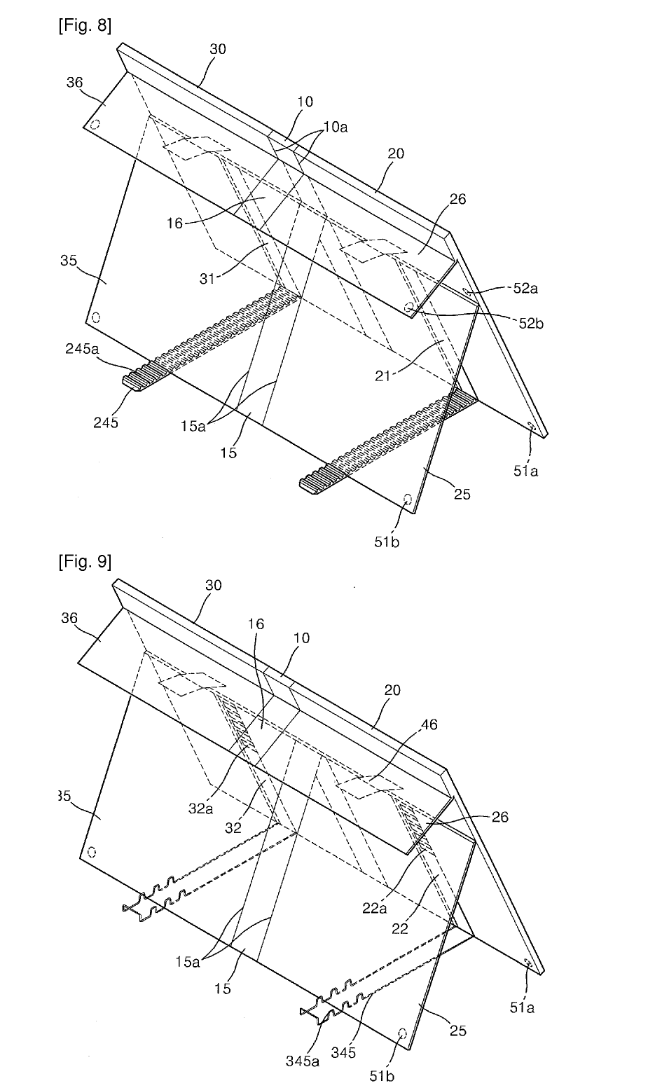

FIG. 8 is a view illustrating a third embodiment of the first angle maintaining part for erecting front and rear covers and first front and rear foldable covers, in the multipurpose cover supporter shown in FIG. 1.

A third embodiment 245 of the first angle maintaining part can be realized in the structure shown in FIG. 8. That is to say, the first angle maintaining parts 245 can comprise members which are foldably connected to the lower ends of the front and rear covers 20 and 30 and are formed with a plurality of projections 245a such that the lower ends of the first front and rear foldable covers 25 and 35 can be fitted between the projections 245a. Fitting grooves 21 and 31 are respectively defined in the front and rear covers 20 and 30 such that the first angle maintaining parts 245 can be fitted into the fitting grooves 21 and 31. Preferably, the fitting grooves 21 and 31 are defined on the outer or inner surfaces of the front and rear covers 20 and 30.

FIG. 9 is a view illustrating a fourth embodiment of the first angle maintaining part for erecting front and rear covers and first front and rear foldable covers, in the multipurpose cover supporter shown in FIG. 1.

A fourth embodiment 345 of the first angle maintaining part can be realized in the structure shown in FIG. 9. That is to say, the first angle maintaining parts 345 can comprise members which are foldably connected to the lower ends of the front and rear covers 20 and 30 and are formed with a plurality of projections 345a such that the lower ends of the first front and rear foldable covers 25 and 35 can be fitted between the projections 345a and that the projections 345a can be engaged into a plurality of engagement grooves 22a and 32a defined on the outer surfaces of the front and rear covers 20 and 30. Here, the engagement grooves 22a and 32a are defined in fitting grooves 22 and 32 which are defined on the outer or inner surfaces of the front and rear covers 20 and 30 so as to be elongate. The first angle maintaining part 345 has a rectangular shape when viewed in its entirety and can be realized by bending a wire such that the projections 345a are formed.

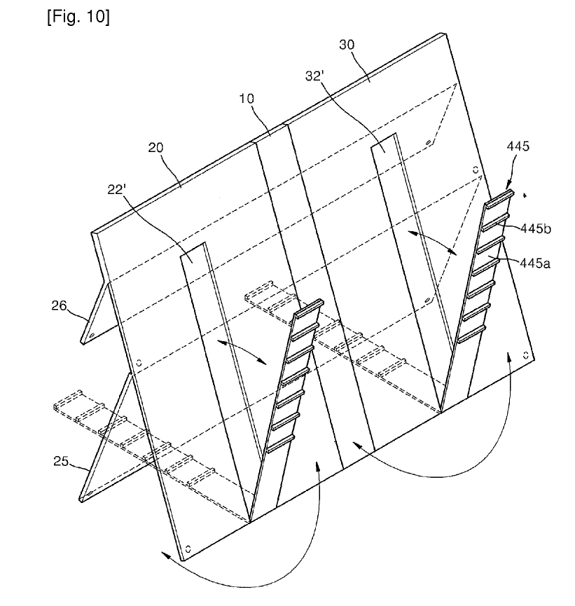

FIG. 10 is a view illustrating a fifth embodiment of the first angle maintaining part for erecting front and rear covers and first front and rear foldable covers, in the multipurpose cover supporter shown in FIG. 1.

A fifth embodiment 445 of the first angle maintaining part can be realized in the structure shown in FIG. 10. That is to say, each first angle maintaining part 445 can be realized by attaching projections 445b as independent constituents to a plate member 445a having a rectangular shape through forming or welding.

When the first angle maintaining parts 445 are not used, as shown in FIG. 10, they can be fitted into fitting grooves 22′ and 32′ which are respectively defined on the inner surfaces of the front and rear covers 20 and 30 to be elongate. Of course, the fitting grooves, into which the first angle maintaining parts 445 are fitted, may be defined on the outer surfaces of the front and rear covers 20 and 30.

The third through fifth embodiments of the first angle maintaining part can be realized by a single component part. In this case, each first angle maintaining part 245, 345 and 445 can be connected between the main connection part 10 and the sub connection part 15.

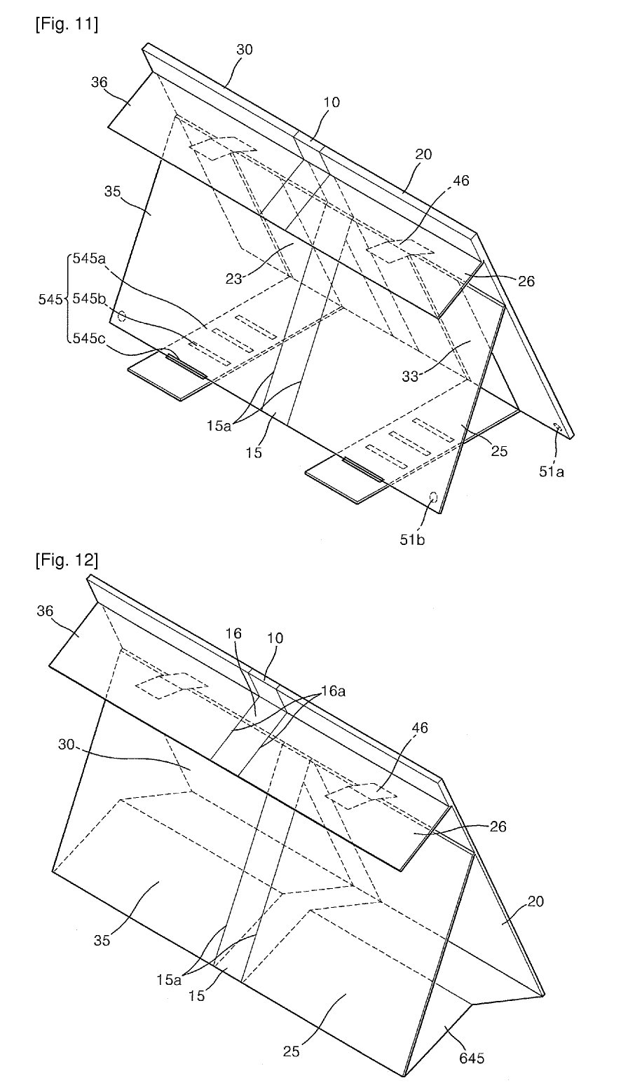

FIG. 11 is a view illustrating a sixth embodiment of the first angle maintaining part for erecting front and rear covers and first front and rear foldable covers, in the multipurpose cover supporter shown in FIG. 1.

A sixth embodiment 545 of the first angle maintaining part can be realized in the structure shown in FIG. 11. That is to say, the first angle maintaining parts 545 can be composed of plate members 545a which are foldably connected to the lower ends of the front and rear covers 20 and 30 and in which first magnetic elements 545b are embedded at predetermined intervals, and second magnetic elements 545c which are embedded in the lower ends of the first front and rear foldable covers 25 and 35 and can be attached to and detached from the first magnetic elements 545b. It is preferred that fitting grooves 23 and 33 be respectively defined in the front and rear covers 20 and 30 such that the first angle maintaining parts 545 can be fitted into the fitting grooves 23 and 33. The portions of the plate members 545a, to which the second magnetic elements 545c are attached, may be formed in such a way as to be protruded or depressed.

FIG. 12 is a view illustrating a seventh embodiment of the first angle maintaining part for erecting front and rear covers and first front and rear foldable covers, in the multipurpose cover supporter shown in FIG. 1.

Referring to FIG. 12, a seventh embodiment 645 of the first angle maintaining part can be realized by a sheet member which connects the entire lower end surfaces of the front and rear covers 20 and 30 with the entire lower end surfaces of the first front and rear foldable covers 25 and 35 and has a folding line formed along the middle portion thereof so that it can be folded along the folding line.

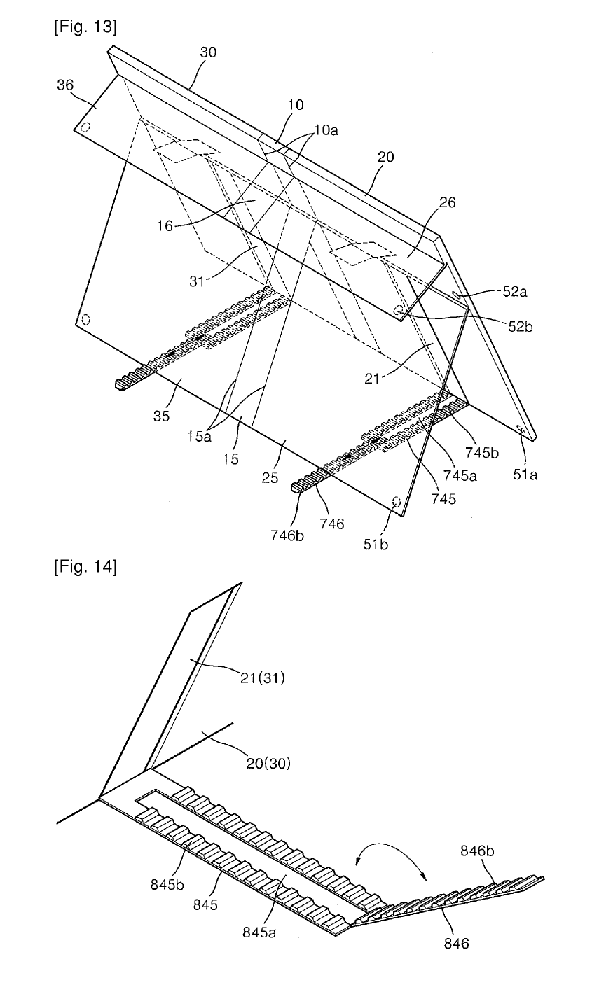

FIG. 13 is a view illustrating an eighth embodiment of the first angle maintaining part for erecting front and rear covers and first front and rear foldable covers, in the multipurpose cover supporter shown in FIG. 1.

Referring to FIG. 13, an eighth embodiment of the first angle maintaining part includes body members 745 which are foldably connected to the lower ends of the front and rear covers 20 and 30, are defined with guide grooves 745a in the middle portions thereof and are formed on the upper surfaces thereof with a plurality of first projections 745b for allowing the lower ends of the first front and rear foldable covers 25 and 35 to be fitted therebetween, and sliders 746 which can be slid along the guide grooves 745a and are formed on the upper surfaces thereof with a plurality of second projections 746b for allowing the lower ends of the first front and rear foldable covers 25 and 35 to be fitted therebetween. By this structure, the sliders 746 can be slid out of the body members 745 toward the first front and rear foldable covers 25 and 35, and in this state, the lower ends of the first front and rear foldable covers 25 and 35 can be fitted between the first projections 745b and/or the second projections 746b. At this time, the erection angle of the multipurpose cover supporter according to the present invention can be changed depending upon the position of the lower ends of the first front and rear foldable covers 25 and 35 which are fitted between the first and/or second projections 745b and 746b.

FIG. 14 is a view illustrating a ninth embodiment of the first angle maintaining part for erecting front and rear covers and first front and rear foldable covers, in the multipurpose cover supporter shown in FIG. 1.

Referring to FIG. 14, a ninth embodiment of the first angle maintaining part includes body members 845 which are foldably connected to the lower ends of the front and rear covers 20 and 30, are defined with guide grooves 845a in the middle portions thereof and are formed on the upper surfaces thereof with a plurality of first projections 845b for allowing the lower ends of the first front and rear foldable covers 25 and 35 to be fitted therebetween, and rotation bars 846 which are rotatably coupled to the ends of the body members 845 to be engaged into or disengaged from the guide grooves 845a and are formed on the upper surfaces thereof with a plurality of second projections 846b for allowing the lower ends of the first front and rear foldable covers 25 and 35 to be fitted therebetween. By this structure, the rotation bars 846 can be rotated at the ends of the body members 845 toward the first front and rear foldable covers 25 and 35, and in this state, the lower ends of the first front and rear foldable covers 25 and 35 can be fitted between the first projections 845b and/or the second projections 846b. At this time, the erection angle of the multipurpose cover supporter according to the present invention can be changed depending upon the position of the lower ends of the first front and rear foldable covers 25 and 35 which are fitted between the first and/or second projections 845b and 846b.

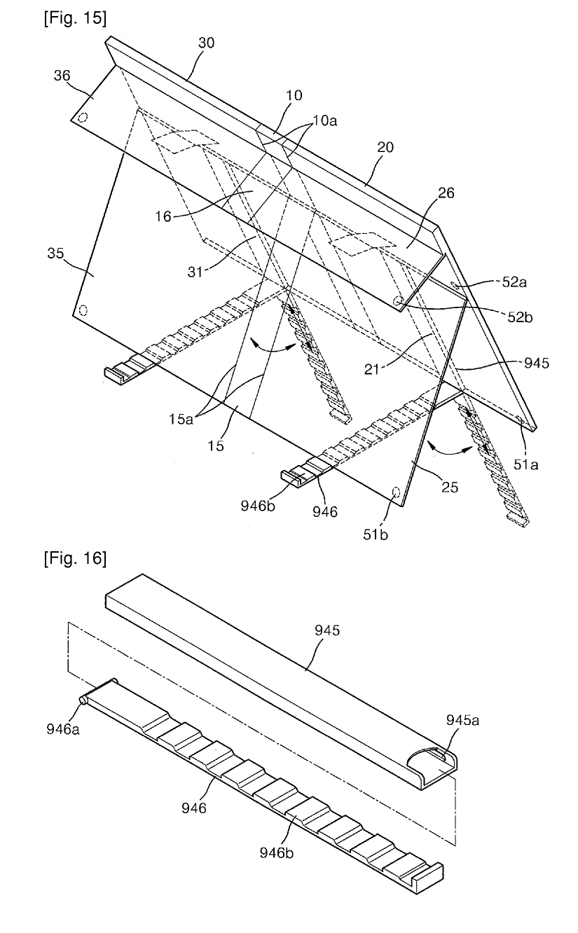

FIG. 15 is a view illustrating a tenth embodiment of the first angle maintaining part for erecting front and rear covers and first front and rear foldable covers, in the multipurpose cover supporter shown in FIG. 1, and FIG. 16 is an exploded perspective view independently illustrating the first angle maintaining part shown in FIG. 15.

Referring to FIGS. 15 and 16, a tenth embodiment of the first angle maintaining part includes guide tubes 945 which are respectively embedded in the front and rear covers 20 and 30 in the vertical direction and are formed on the ends thereof with release prevention protrusions 945a, and sliders 946 which can be slid along the guide tubes 945, have release prevention projections 946a to be engaged with the release prevention protrusions 945a and are formed on the upper surfaces thereof with a plurality of projections 946b for allowing the lower ends of the first front and rear foldable covers 25 and 35 to be fitted therebetween. By this structure, after the sliders 946 are slid out of the guide tubes 945 and the release prevention projections 946a are engaged with the release prevention protrusions 945a, the sliders 946 are rotated toward the first front and rear foldable covers 25 and 35, and in this state, the lower ends of the first front and rear foldable covers 25 and 35 can be fitted between the projections 946b. At this time, the erection angle of the multipurpose cover supporter according to the present invention can be changed depending upon the position of the lower ends of the first front and rear foldable covers 25 and 35 which are fitted between the projections 946b.

As aforementioned above, it is to be noted that the first angle maintaining part can be realized in a variety of shapes in addition to the above-described shapes such that it has various fastening and length adjustment structures.

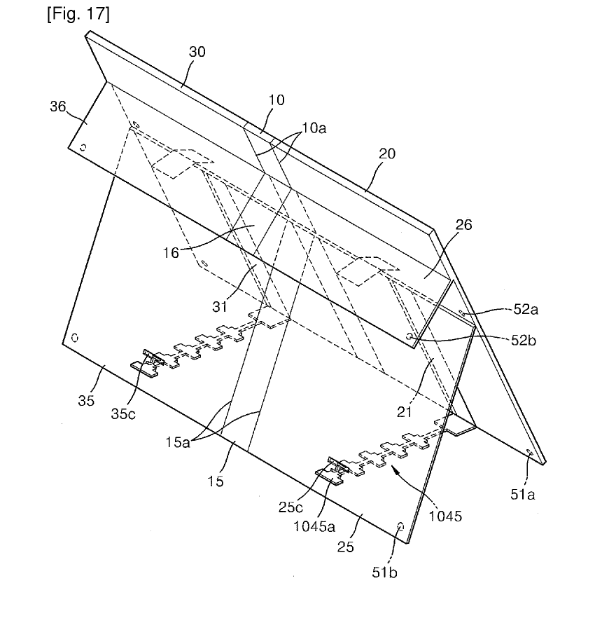

FIG. 17 is a view illustrating an eleventh embodiment of the first angle maintaining part for erecting front and rear covers and first front and rear foldable covers, in the multipurpose cover supporter shown in FIG. 1.

An eleventh embodiment 1045 of the first angle maintaining part is realized by members which are foldably connected to the lower ends of the front and rear covers 20 and 30 and are formed with a plurality of projections 1045a to be fitted through holes 25c and 35c defined in the first front and rear foldable covers 25 and 35. Here, the projections 1045a and the holes 25c and 35c, which are engaged with or disengaged from each other, may have various sectional shapes. By this structure, the erection angle of the multipurpose cover supporter according to the present invention can be changed depending upon the position of the projections 1045a engaged with the holes 25c and 35c.

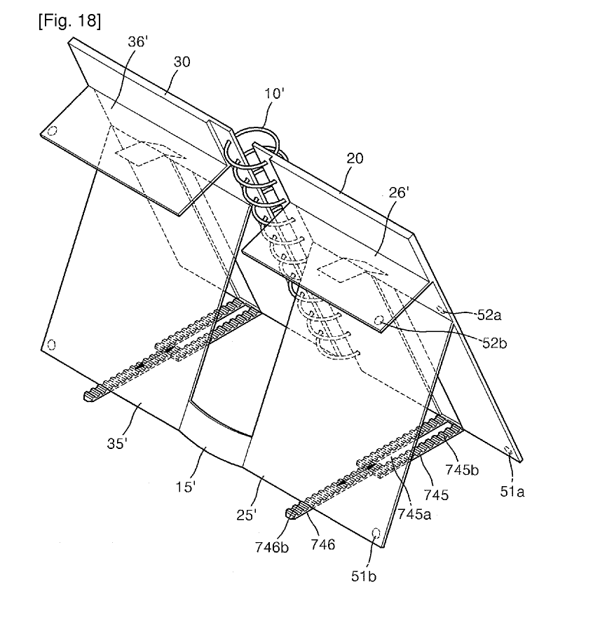

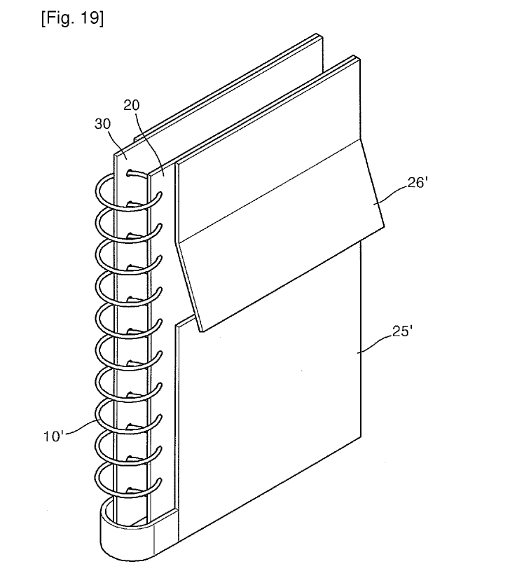

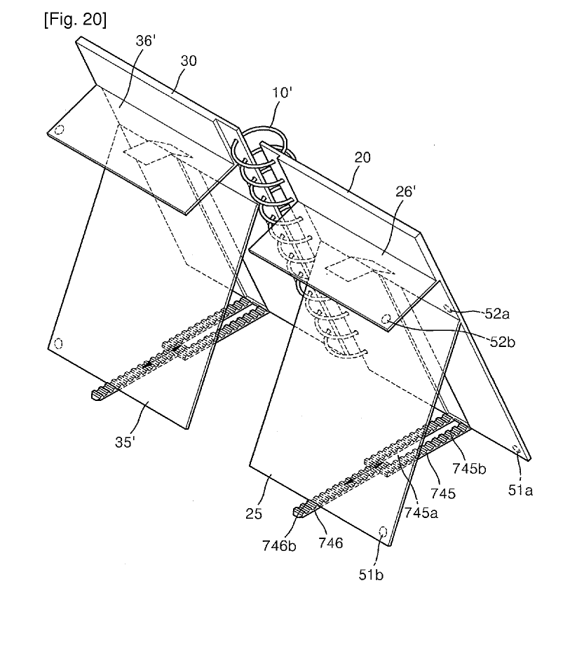

FIG. 18 is a view illustrating a main connection part comprising a spring in the multipurpose cover supporter shown in FIG. 1, FIG. 19 is a view illustrating the state in which the multipurpose cover supporter shown in FIG. 18 is folded like a book, and FIG. 20 is a view illustrating the state in which a connection member for connecting the first front and rear foldable covers is not adopted, in the multipurpose cover supporter shown in FIG. 18.

While the main connection part 10 is heretofore connected to the side ends of the front and rear covers 20 and 30, the main connection part can be constituted by a spring 10′ which connects the front and rear covers 20 and 30 with each other, as shown in FIG. 18. In this case, a first front foldable cover 25′ and a first rear foldable cover 35′ are separately joined to the front and rear covers 20 and 30 on both sides of the main connection part 10′ constituted by the spring so as not to be interfered with by the spring. Also, a second front foldable cover 26′ and a second rear foldable cover 36′ are separately joined to the front and rear covers 20 and 30 on both sides of the main connection part 10′.

Referring to FIG. 18, the first front and rear foldable covers 25′ and 35′ can be connected with each other by a separate connection member 15′. The connection member 15′ can connect partially or wholly the first front and rear foldable covers 25′ and 35′. Of course, the second front and rear foldable covers 26′ and 36′ can be connected with each other by a separate connection member (not shown).

By this structure, the multipurpose cover supporter can be folded like a book as shown in FIG. 19.

Referring to FIG. 20, the connection member 15′ may not be used between the first front and rear foldable covers 25′ and 35′.

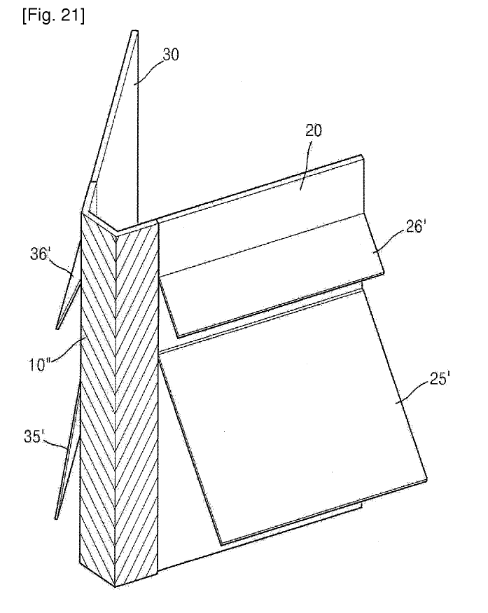

FIG. 21 is a view illustrating the state in which first and second front foldable covers and first and second rear foldable covers are not connected, in the multipurpose cover supporter shown in FIG. 1.

Referring to FIG. 21, in the state in which the first front and rear foldable covers 25′ and 35′ are not connected and the second front and rear foldable covers 26′ and 36′ are not connected, a main connection part 10″ can wholly connect the front and rear covers 20 and 30. At this time, the main connection part 10″ comprises a member which is directly connected to the side ends of the front and rear covers 20 and 30 and may be realized using various materials. The main connection part 10″ may be formed using the same material as the front and rear covers 20 and 30 or other materials.

In the above-described structures, by unfolding the first front and rear foldable covers 25 and 35 from the front and rear covers 20 and 30, the first angle maintaining parts are straightened, and, then, by folding the second front and rear foldable covers 26 and 36 to the front and rear covers 20 and 30, the front and rear covers 20 and 30 can be erected while having a steep slope as shown in FIG. 3.

Also, if the first front and rear foldable covers 25 and 35 are folded to the front and rear covers 20 and 30 and the second front and rear foldable covers 26 and 36 are unfolded from the front and rear covers 20 and 30, the second angle maintaining parts are straightened, and in this state, the front and rear covers 20 and 30 can be erected while having a gentle slope as shown in FIG. 4.

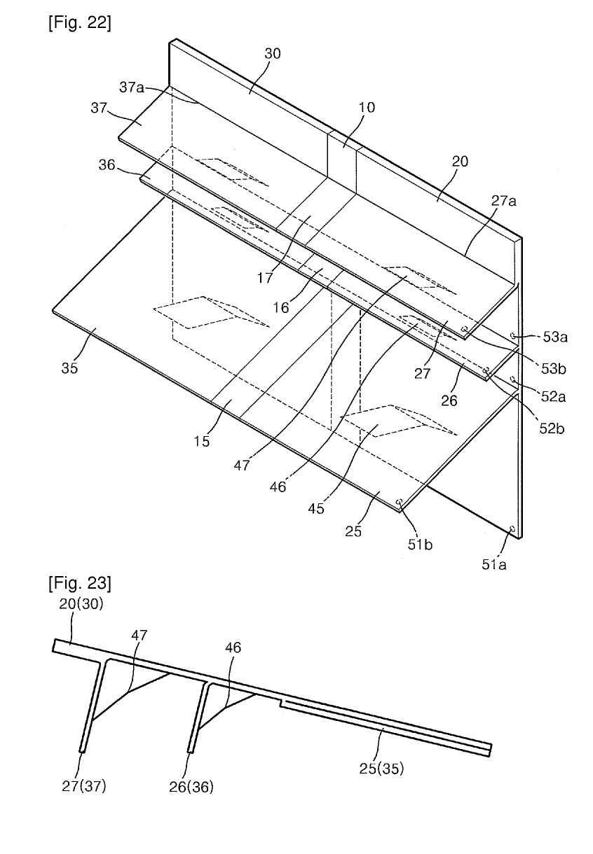

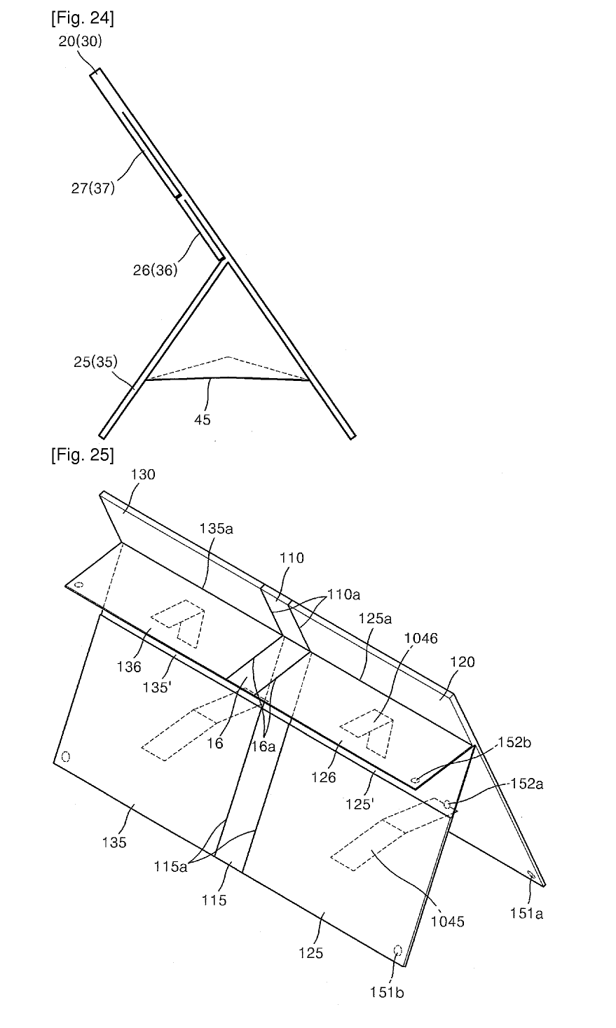

FIG. 22 is a view illustrating third front and rear foldable covers and a third angle maintaining part which are formed above the second front and rear foldable covers, in the multipurpose cover supporter shown in FIG. 1, FIG. 23 is a view illustrating the state in which the front and rear covers are erected by the second and third front and rear foldable covers, in the multipurpose cover supporter shown in FIG. 22, and FIG. 24 is a view illustrating the state in which the front and rear covers are erected by the first front and rear foldable covers, in the multipurpose cover supporter shown in FIG. 22.

Referring to these drawings, third front and rear foldable covers 27 and 37 can be joined to the outer surfaces of the front and rear covers 20 and 30 along third folding lines 27a and 37a above the second front and rear foldable covers 26 and 36 such that the third front and rear foldable covers 27 and 37 can overlap with the front and rear covers 20 and 30. In this case, third angle maintaining parts 47 are provided between the front and rear covers 20 and 30 and the third front and rear foldable covers 27 and 37 to maintain an angle defined therebetween when they are unfolded from each other.

Third attachment parts 53a and 53b are formed on the lower end corners of the third front and rear foldable covers 27 and 37 and the portions of the front and rear covers 20 and 30 which correspond to the lower end corners of the third front and rear foldable covers 27 and 37 such that the third front and rear foldable covers 27 and 37 can be kept in the state in which they overlap with the front and rear covers 20 and 30. The third attachment parts 53a and 53b are substantially the same as the first and second attachment parts 51a and 51b, and 52a and 52b.

While it was exemplified in FIGS. 22 through 24 that three pairs of foldable covers, that is, the first through third front and rear foldable covers are connected to the front and rear covers, it can of course be envisaged that four or more pairs of foldable covers can be provided and connected to the front and rear covers. Also, the widths of the first through third front and rear foldable covers can be changed in various ways.

In the above-described structure, by unfolding the second and third front and rear foldable covers 26 and 36, and 27 and 37 from the front and rear covers 20 and 30, the second and third angle maintaining parts are straightened, and, then, by folding the first front and rear foldable covers 25 and 35 to the front and rear covers 20 and 30, the front and rear covers 20 and 30 can be erected while having a gentle slope as shown in FIG. 23. Also, if the second and third front and rear foldable covers 26 and 36, and 27 and 37 are folded to the front and rear covers 20 and 30 and the first front and rear foldable covers 25 and 35 are unfolded from the front and rear covers 20 and 30, the first angle maintaining parts are straightened, and in this state, the front and rear covers 20 and 30 can be erected while having a steep slope as shown in FIG. 24.

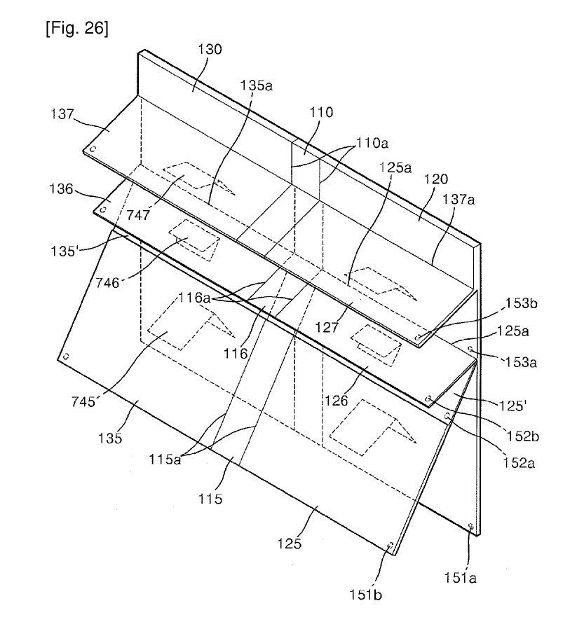

FIG. 25 is a perspective view illustrating a second embodiment of the multipurpose cover supporter according to the present invention, and FIG. 26 is a view illustrating the state in which third front and rear foldable covers and a third angle maintaining part are formed over first and second front and rear foldable covers, in the multipurpose cover supporter shown in FIG. 25.

Referring to these drawings, a second embodiment of a multipurpose cover supporter according to the present invention includes a front cover 120 and a rear cover 130 foldably connected with each other by a main connection part 110; first front and rear foldable covers 125 and 135 connected to the outer surfaces of the front and rear covers 120 and 130 along common folding lines 125a and 135a and overlapping with the front and rear covers 120 and 130; second front and rear foldable covers 126 and 136 connected to the outer surfaces of the first front and rear foldable covers 125 and 135 along the common folding lines 125a and 135a and overlapping with the first front and rear foldable covers 125 and 135; first angle maintaining parts 1045 connected between the front and rear covers 120 and 130 and the first front and rear foldable covers 125 and 135 to maintain an angle defined therebetween when they are unfolded from each other; and second angle maintaining parts 1046 connected between the first front and rear foldable covers 125 and 135 and the second front and rear foldable covers 126 and 136 to maintain an angle defined therebetween when they are unfolded from each other.

At this time, preferably, as shown in FIG. 5, detachable support parts 160 for detachably supporting inner sheets (not shown) to be printed with a variety of information or to be recorded with something are installed on the main connection part 110 and on any one or both of the front cover 120 and the rear cover 130.

The detachable support parts 160 can be realized in various shapes. For example, as shown in FIG. 7, the detachable support part 160 can comprise first attachment and detachment portions 161 which are installed on the main connection part 110 at predetermined intervals, an inner sheet support portion 163 having pockets 163a and 163b into which the front and rear surface portions of a book or other various inner sheets are respectively fitted, and second attachment and detachment portions 162 which are installed at a place where the inner sheet support portion 163 is to be bound and which are attached to and detached from the first attachment and detachment portions 161. At this time, the first and second attachment and detachment portions 161 and 162 can be realized by magnets and steel pieces, or magnets having opposite polarities.

Further, the detachable support part can be realized by a conventional spring binder which is installed on the main connection part 110, a clip which is installed on the upper end of any one of the front cover 120 and the rear cover 130 and detachably supports the upper ends of the inner sheets, a pocket which is formed on the inner surface of the front cover 120 and/or the rear cover 130 to allow memo papers or name cards to be slipped therein, or a plurality of vinyl pouches which are installed on the main connection part 110 to receive papers. Besides, the detachable support part can be realized by rubber bands which are installed on the front cover 120 and the rear cover 130, respectively, in the longitudinal direction.

Since the materials of the front and rear covers and the first and second front and rear foldable covers are substantially the same as those described in the first embodiment of the multipurpose cover supporter, further description thereof will be omitted herein.

The height of the first front and rear foldable covers 125 and 135 is determined to be greater than the height of the second front and rear foldable covers 126 and 136.

Also, while it is illustrated that the common folding lines 125a and 135a are formed on the upper portions of the front and rear covers 120 and 130, it can of course be envisaged that the common folding lines 125a and 135a can be formed on the upper ends of the front and rear covers 120 and 130.

Step portions 125′ and 135′ are formed on the first front and rear foldable covers 125 and 135 such that the second front and rear foldable covers 126 and 136 can be fitted into the step portions 125′ and 135′. The step portions 125′ and 135′ have a thickness less than the first front and rear foldable covers 125 and 135. It is preferred that, when the second front and rear foldable covers 126 and 136 are fitted into the step portions 125′ and 135′, the entire thickness of the second front and rear foldable covers 126 and 136 and the step portions 125′ and 135′ be equal to the thickness of the first front and rear foldable covers 125 and 135.

The main connection part 110 connects the front cover 120 and the rear cover 130 along folding lines 110a on both side ends thereof. The first front foldable cover 125 and the first rear foldable cover 135 are connected with each other by a first sub connection part 115 along folding lines 115a, and the second front foldable cover 126 and the second rear foldable cover 136 are connected with each other by a second sub connection part 116 along folding lines 116a.

First attachment parts 151a and 151b are formed on the lower end corners of the first front and rear foldable covers 125 and 135 and on the lower end corners of the front and rear covers 120 and 130 such that the first front and rear foldable covers 125 and 135 can be kept in the state in which they overlap with the front and rear covers 120 and 130.

Second attachment parts 152a and 152b are formed on the lower end corners of the second front and rear foldable covers 126 and 136 and the portions of the first front and rear foldable covers 125 and 135 which correspond to the lower end corners of the second front and rear foldable covers 126 and 136 such that the second front and rear foldable covers 126 and 136 can be kept in the state in which they overlap with the first front and rear foldable covers 125 and 135. The first and second attachment parts 151a and 151b, and 152a and 152b are substantially the same as the first and second attachment parts 51a and 51b, and 52a and 52b of the first embodiment.

The second angle maintaining parts 1046 function to hold the second front and rear foldable covers 126 and 136 and the first front and rear foldable covers 125 and 135 in the unfolded state so as to allow the multipurpose cover supporter according to the present invention to be erected. The second angle maintaining parts 1046 comprise band members which are connected between and fastened to the second front and rear foldable covers 126 and 136 and the first front and rear foldable covers 125 and 135. The second angle maintaining parts 1046 are folded when the second front and rear foldable covers 126 and 136 are folded to the first front and rear foldable covers 125 and 135.

The first angle maintaining parts 1045 function to hold the front and rear covers 120 and 130 and the first front and rear foldable covers 125 and 135 in the unfolded state so as to allow the multipurpose cover supporter according to the present invention to be erected at a different angle. The first angle maintaining parts 1045 can be realized in various shapes. Since the first angle maintaining parts 1045 are substantially similar to the first angle maintaining parts of the first embodiment, further detailed description thereof will be omitted herein.

Meanwhile, as shown in FIG. 26, third front and rear foldable covers 127 and 137 can be connected to the outer surfaces of the front and rear covers 120 and 130 along folding lines 127a and 137a above the common folding lines 125a and 135a to overlap with the front and rear covers 120 and 130. In this case, third angle maintaining parts 747 are connected between the front and rear covers 120 and 130 and the third front and rear foldable covers 127 and 137 to maintain an angle defined therebetween when they are unfolded from each other. While it was exemplified in the embodiment of FIG. 26 that three pairs of foldable covers, that is, the first through third front and rear foldable covers are connected to the front and rear covers, it can of course be envisaged that four or more pairs of foldable covers can be provided and connected to the front and rear covers. Also, the widths of the first through third front and rear foldable covers can be changed in various ways.

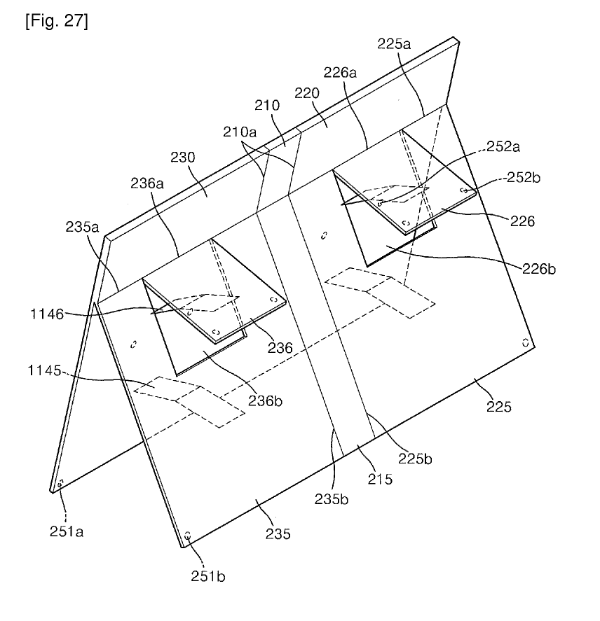

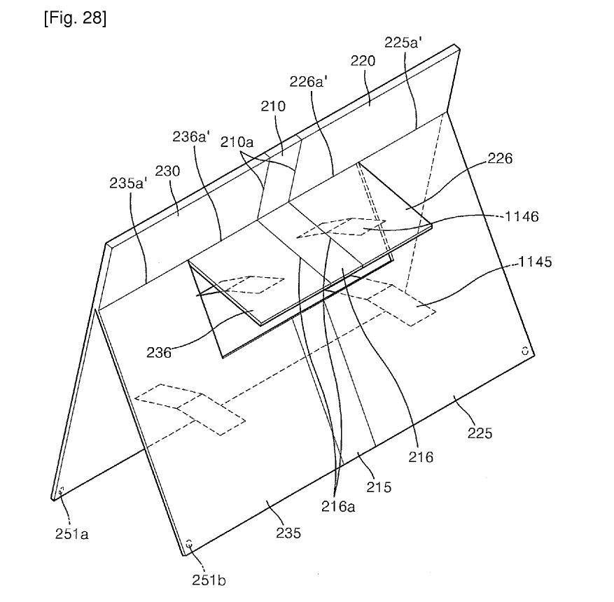

FIG. 27 is a perspective view illustrating a third embodiment of the multipurpose cover supporter according to the present invention, and FIG. 28 is a view illustrating the state in which a second front foldable cover and a second rear foldable cover are connected by a sub connection part, in the multipurpose cover supporter shown in FIG. 27.

Referring to these drawings, a third embodiment of a multipurpose cover supporter according to the present invention includes a front cover 220 and a rear cover 230 foldably connected with each other by a main connection part 210; first front and rear foldable covers 225 and 235 connected to the outer surfaces of the front and rear covers 220 and 230 along folding lines 225a and 235a, overlapping with the front and rear covers 220 and 230, and defined with front and rear openings 226b and 236b; second front and rear foldable covers 226 and 236 positioned in the front and rear openings 226b and 236b, connected to the outer surfaces of the front and rear covers 220 and 230 along folding lines 226a and 236a inside the front and rear openings 226b and 236b, and overlapping with the front and rear covers 220 and 230; first angle maintaining parts 1145 connected between the front and rear covers 220 and 230 and the first front and rear foldable covers 225 and 235 to maintain an angle defined therebetween when they are unfolded from each other; and second angle maintaining parts 1146 connected between the front and rear covers 220 and 230 and the second front and rear foldable covers 226 and 236 to maintain an angle defined therebetween when they are unfolded from each other.

At this time, detachable support parts (not shown) as described in the first and second embodiments of the multipurpose cover supporter according to the present invention are installed on the main connection part 210 and on any one or both of the front cover 220 and the rear cover 230.

The main connection part 210 connects the front cover 220 and the rear cover 230 along folding lines 210a on both side ends thereof. The first front foldable cover 225 and the first rear foldable cover 235 are connected with each other by a first sub connection part 215 along folding lines 215a.

First attachment parts 251a and 251b are formed on the lower end corners of the first front and rear foldable covers 225 and 235 and on the lower end corners of the front and rear covers 220 and 230 such that the first front and rear foldable covers 225 and 235 can be kept in the state in which they overlap with the front and rear covers 220 and 230.

Second attachment parts 252a and 252b are formed on the lower end corners of the second front and rear foldable covers 226 and 236 and the portions of the front and rear covers 220 and 230 which correspond to the lower end corners of the second front and rear foldable covers 226 and 236 such that the second front and rear foldable covers 226 and 236 can be kept in the state in which they overlap with the front and rear covers 220 and 230. The first and second attachment parts 251a and 251b, and 252a and 252b are substantially the same as the first and second attachment parts 51a and 51b, and 52a and 52b of the first embodiment.

The first angle maintaining parts 1145 function to hold the front and rear covers 220 and 230 and the first front and rear foldable covers 225 and 235 in the unfolded state so as to allow the multipurpose cover supporter according to the present invention to be erected at a different angle. The first angle maintaining parts 1145 can be realized in various shapes. Since the first angle maintaining parts 1145 are substantially similar to the first angle maintaining parts of the first embodiment, further detailed description thereof will be omitted herein.

The second angle maintaining parts 1146 function to hold the second front and rear foldable covers 226 and 236 and the front and rear covers 220 and 230 in the unfolded state so as to allow the multipurpose cover supporter according to the present invention to be erected. It is preferred that the second angle maintaining parts 1146 comprise band members which are connected between and fastened to the second front and rear foldable covers 226 and 236 and the front and rear covers 220 and 230. The second angle maintaining parts 1146 are folded when the second front and rear foldable covers 226 and 236 are folded to the front and rear covers 220 and 230.

Meanwhile, as shown in FIG. 28, front and rear openings can communicate with each other, and the second front foldable cover 226 and the second rear foldable cover 236 can be connected with each other along folding lines 216a. In this case, the second front foldable cover 226 and the second rear foldable cover 236 are connected with each other by a second sub connection part 216 along the folding lines 216a.

Moreover, it can of course be envisaged that the folding lines 225a and 235a for connecting the first front and rear foldable covers 225 and 235 and the front and rear covers 220 and 230 and the folding lines 226a and 236a for connecting the second front and rear foldable covers 226 and 236 and the front and rear covers 220 and 230 may not be aligned in line unlike the present embodiment.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A multipurpose cover supporter comprising:
a front cover (20) and a rear cover (30) foldably connected with each other by a main connection part (10);
first front and rear foldable covers (25 and 35) connected to outer surfaces of the front and rear covers (20 and 30) along first folding lines (25a and 35a) and overlapping with the front and rear covers (20 and 30);
second front and rear foldable covers (26 and 36) connected to the outer surfaces of the front and rear covers (20 and 30) along second folding lines (26a and 36a) above the first front and rear foldable covers (25 and 35) and overlapping with the front and rear covers (20 and 30);
first angle maintaining parts connected between the front and rear covers (20 and 30) and the first front and rear foldable covers (25 and 35) to maintain an angle defined therebetween when they are unfolded from each other; and
second angle maintaining parts connected between the front and rear covers (20 and 30) and the second front and rear foldable covers (26 and 36) to maintain an angle defined therebetween when they are unfolded from each other.

2. The multipurpose cover supporter according to claim 1, further comprising:
first attachment parts (51a and 51b) formed on lower end corners of the first front and rear foldable covers (25 and 35) and on the front and rear covers (20 and 30) such that the first front and rear foldable covers (25 and 35) can be kept in the state in which they overlap with the front and rear covers (20 and 30); and
second attachment parts (52a and 52b) formed on lower end corners of the second front and rear foldable covers (26 and 36) and on the front and rear covers (20 and 30) such that the second front and rear foldable covers (26 and 36) can be kept in the state in which they overlap with the front and rear covers (20 and 30).

3. The multipurpose cover supporter according to claim 1, wherein the first angle maintaining parts (45) comprise band members which are connected between and fastened to the front and rear covers (20 and 30) and the first front and rear foldable covers (25 and 35).

4. The multipurpose cover supporter according to claim 1, wherein the first angle maintaining parts (145) comprise band members (145a) which are connected to the first front and rear foldable covers (25 and 35) and are fastened to lower portions of the front and rear covers (20 and 30), first attachment and detachment elements (145b) which are formed on upper portions of the front and rear covers (20 and 30) at preselected intervals, and second attachment and detachment elements (145c) which are installed on the band members (145a) and can be attached to and detached from the first attachment and detachment elements (145b).

5. The multipurpose cover supporter according to claim 1, wherein the first angle maintaining parts (245) comprise members which are foldably connected to lower ends of the front and rear covers (20 and 30) and are formed with a plurality of projections (245a) such that lower ends of the first front and rear foldable covers (25 and 35) can be fitted between the projections (245a)

6-7. (canceled)

8. The multipurpose cover supporter according to claim 1, wherein the first angle maintaining parts comprise body members (745) which are foldably connected to lower ends of the front and rear covers (20 and 30), are defined with guide grooves (745a) in middle portions thereof and are formed on upper surfaces thereof with a plurality of first projections (745b) for allowing lower ends of the first front and rear foldable covers (25 and 35) to be fitted therebetween, and sliders (746) which can be slid along the guide grooves (745a) and are formed on upper surfaces thereof with a plurality of second projections (746b) for allowing the lower ends of the first front and rear foldable covers (25 and 35) to be fitted therebetween.

9-10. (canceled)

11. The multipurpose cover supporter according to claim 1, wherein the first angle maintaining parts (1045) comprise members which are foldably connected to lower ends of the front and rear covers (20 and 30) and are formed with a plurality of projections (1045a) to be fitted through holes (25c and 35c) defined in the first front and rear foldable covers (25 and 35).

12. The multipurpose cover supporter according to claim 1, further comprising:
third front and rear foldable covers (27 and 37) connected to the outer surfaces of the front and rear covers (20 and 30) along third folding lines (27a and 37a) above the second front and rear foldable covers (26 and 36) such that the third front and rear foldable covers (27 and 37) can overlap with the front and rear covers (20 and 30); and
third angle maintaining parts (47) connected between the front and rear covers (20 and 30) and the third front and rear foldable covers (27 and 37) to maintain an angle defined therebetween when they are unfolded from each other.

13. The multipurpose cover supporter according to claim 1, further comprising: detachable support parts 60 installed on the main connection part (10) and on any one or both of the front cover (20) and the rear cover (30) to detachably support inner sheets which are to be printed with a variety of information or to be recorded with something.

14. The multipurpose cover supporter according to claim 13, wherein the detachable support part comprises first attachment and detachment portions (61) which are installed on the main connection part (10) at predetermined intervals, an inner sheet support portion (63) having pockets (63a and 63b) into which front and rear surface portions of inner sheets are respectively fitted, and second attachment and detachment portions (62) which are installed at a place where the inner sheet support portion (63) is to be bound and which can be attached to and detached from the first attachment and detachment portions (61).

15. The multipurpose cover supporter according to claim 1, wherein the main connection part (10′) comprises a spring, the first front foldable cover (25′) and the first rear foldable cover (35′) are separately connected to the front and rear covers (20 and 30) on both sides of the main connection part (10′) constituted by the spring, and the second front foldable cover (26′) and the second rear foldable cover (36′) are separately connected to the front and rear covers (20 and 30) on both sides of the main connection part (10′), so as not to be interfered with by the spring.

16. The multipurpose cover supporter according to claim 15, further comprising: a connection member connecting the first front and rear foldable covers (25′ and 35′), the second front and rear foldable covers (26′ and 36′), or the front and rear covers (20 and 30).

17. A multipurpose cover supporter comprising:
a front cover (120) and a rear cover (130) foldably connected with each other by a main connection part (110);
first front and rear foldable covers (125 and 135) connected to outer surfaces of the front and rear covers (120 and 130) along common folding lines (125a and 135a) and overlapping with the front and rear covers (120 and 130);
second front and rear foldable covers (126 and 136) connected to the outer surfaces of the first front and rear foldable covers (125 and 135) along the common folding lines (125a and 135a) and overlapping with the first front and rear foldable covers (125 and 135);
first angle maintaining parts (1045) connected between the front and rear covers (120 and 130) and the first front and rear foldable covers (125 and 135) to maintain an angle defined therebetween when they are unfolded from each other; and
second angle maintaining parts (1046) connected between the first front and rear foldable covers (125 and 135) and the second front and rear foldable covers (126 and 136) to maintain an angle defined therebetween when they are unfolded from each other.

18. The multipurpose cover supporter according to claim 17, further comprising:
step portions (125′ and 135′) respectively formed on the first front and rear foldable covers (125 and 135) such that the second front and rear foldable covers (26 and 136) can be fitted into the step portions (125′ and 135′).

19. The multipurpose cover supporter according to claim 17, further comprising:
first attachment parts (151a and 151b) formed on lower end corners of the first front and rear foldable covers (125 and 135) and on the front and rear covers (120 and 130) such that the first front and rear foldable covers (125 and 135) can be kept in the state in which they overlap with the front and rear covers (120 and 130); and
second attachment parts (152a and 152b) formed on lower end corners of the second front and rear foldable covers (126 and 136) and the first front and rear foldable covers (125 and 135) such that the second front and rear foldable covers (126 and 136) can be kept in the state in which they overlap with the first front and rear foldable covers (125 and 135).

20. The multipurpose cover supporter according to claim 17, further comprising:
third front and rear foldable covers (127 and 137) connected to the outer surfaces of the front and rear covers (120 and 130) along folding lines (127a and 137a) above the common folding lines (125a and 135a) to overlap with the front and rear covers (120 and 130); and
third angle maintaining parts (747) connected between the front and rear covers (120 and 130) and the third front and rear foldable covers (127 and 137) to maintain an angle defined therebetween when they are unfolded from each other.

21. The multipurpose cover supporter according to claim 17, further comprising: detachable support parts (160) installed on the main connection part (110) and on any one or both of the front cover (120) and the rear cover (130) to detachably support inner sheets which are to be printed with a variety of information or to be recorded with something.

22. The multipurpose cover supporter according to claim 21, wherein the detachable support part (160) comprises first attachment and detachment portions (161) which are installed on the main connection part (110) at predetermined intervals, an inner sheet support portion (163) having pockets (163a and 163b) into which front and rear surface portions of inner sheets are respectively fitted, and second attachment and detachment portions (162) which are installed at a place where the inner sheet support portion (163) is to be bound and which are attached to and detached from the first attachment and detachment portions (161).

23. A multipurpose cover supporter comprising:
a front cover (220) and a rear cover (230) foldably connected with each other by a main connection part (210);
first front and rear foldable covers (225 and 235) connected to outer surfaces of the front and rear covers (220 and 230) along folding lines (225a and 235a), overlapping with the front and rear covers (220 and 230), and defined with front and rear openings (226b and 236b);
second front and rear foldable covers (226 and 236) positioned in the front and rear openings (226b and 236b), connected to the outer surfaces of the front and rear covers (220 and 230) along folding lines (226a and 236a) inside the front and rear openings (226b and 236b), and overlapping with the front and rear covers (220 and 230);
first angle maintaining parts (1145) connected between the front and rear covers (220 and 230) and the first front and rear foldable covers (225 and 235) to maintain an angle defined therebetween when they are unfolded from each other; and
second angle maintaining parts (1146) connected between the front and rear covers (220 and 230) and the second front and rear foldable covers (226 and 236) to maintain an angle defined therebetween when they are unfolded from each other.

24. The multipurpose cover supporter according to claim 23, wherein the front and rear openings (226b and 236b) communicate with each other, and the second front foldable cover (226) and the second rear foldable cover (236) are connected with each other along folding lines (216a).
